(19) United States
(12) Patent Application Publication
(10) Pub. No.: US 2014/0302926 A1
(43) Pub. Date: Oct. 9, 2014

(54) System and Method for Processing Video Content of Electronic Gaming Machines

(71) Applicant: Incredible Technologies, Inc., Vernon Hills, IL (US)

(72) Inventors: Scott J. Schoenberg, Highland Park, IL (US); Daniel J. Schrementi, Lombard, IL (US); Mark Tulewicz, Harwood Heights, IL (US)

(73) Assignee: Incredible Technologies, Inc., Vernon Hills, IL (US)

(21) Appl. No.: 14/245,744

(22) Filed: Apr. 4, 2014

Related U.S. Application Data
(60) Provisional application No. 61/809,058, filed on Apr. 5, 2013.

(51) Int. Cl. G07F 17/32

(52) U.S. Cl. CPC G07F 17/3225
USPC 463/31

(57) ABSTRACT

A system and method for processing video content of an electronic gaming machine featuring at least one electronic gaming machine, a common server operatively connected to the gaming machine, a dedicated storage device and data transmission circuitry. The gaming machine featuring a central processor and associated circuitry for generating video of a game played thereon and creating a video file. The server having storage and first data transmission circuitry for transmission of the video file to the dedicated storage device. The dedicated storage device being in wired or wireless communication with the server and having data acquisition circuitry for receiving the video file from the server. The data transmission circuitry electrically contented to the at least one electronic gaming machine or central server for one-way electronic transmission of the video file to an external device via a public or private data network.

### CROSS REFERENCE TO RELATED APPLICATION

This application claims the benefit of U.S. Provisional Patent Application Ser. No. 61/809,058 filed Apr. 5, 2013, the entirety of which is hereby incorporated by reference as if fully set forth herein.

### FIELD

The invention pertains to systems and methods for processing electronic video content produced in connection with electronic gaming machines. More particularly, the invention pertains to such systems and methods for transmitting and maintaining video content of games played on electronic gaming machines.

### BACKGROUND

Electronic gaming machines (“EGMs”) are generally well known and have been relatively popular for a number of years. Examples of such machines include for example, video slot machines, video poker machines, bar-top gaming devices, and coin-operated amusement devices. As is customary with such machines, a display is usually provided which visually presents dynamic electronic video images on a two or three dimensional array. During play of games on such EGMs, visual images presented on the display can be electronically refreshed or changed to produce a dynamic video images which can present visual feedback to a player as to the progress or play of the game, such as for example movement or manipulation of game elements. Such video can be additionally accompanied by audio signals, sounds or music which can further enhance a player's gaming experience.

As is typical, an EGM display unit electronically presents the progress and outcome of the game to a player and once a game is complete, a new game is initiated or the game enters a standby or attract mode in which one or more predetermined dynamic or static images are presented in order to attract new players. Accordingly, video of game play from previous games is typically not saved and thus cannot be accessed, replayed or presented on the machine's display or elsewhere.

Instead, once a game is complete and an outcome is obtained, electronic gaming devices either: (a) store the outcome of each game as a summary in text format; (b) store the outcome of the game in such a way that the stored outcome data can be used to re-create the play in visual form on the individual gaming device, or (c) both. Such practices have a number of limitations in that they may require the original game device to reply or reproduce a visual reproduction of a game, do not provide an opportunity to view the progress of the game in real time at a location remote to the gaming machine, and are subject to producing a divergent record of game data in instances where, for example, the outcome summary data was stored correctly but the video screen showed the wrong result (or vice versa).

In view of such limitations, there is a need in the art for a system and method for securely processing video content generated in connection with an EGM and for further electronically transmitting and/or storing such video to a remote electronic device which can access and replay the video in real-time or on demand. As described herein, such systems and methods are useful for a variety of applications, including, for example, promotional, maintenance, security, game development and/or entertainment purposes.

### BRIEF DESCRIPTION OF THE DRAWINGS

FIG. 1 is a block diagram illustrating a representational view of a system in accordance herewith.

FIG. 2 is a block diagram illustrating a representational EGM incorporating the system and methods in accordance herewith.

FIG. 3 is flowchart showing a method in accordance with embodiments of the subject invention.

### DETAILED DESCRIPTION

While this invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated.

As described herein, embodiments of the subject invention are directed to a system and method of securely processing and transmitting video content of a game played on an electronic gaming machine. According to such embodiments, the system and method presented herein can enable the video to be accessed and/or viewed at remote locations on demand.

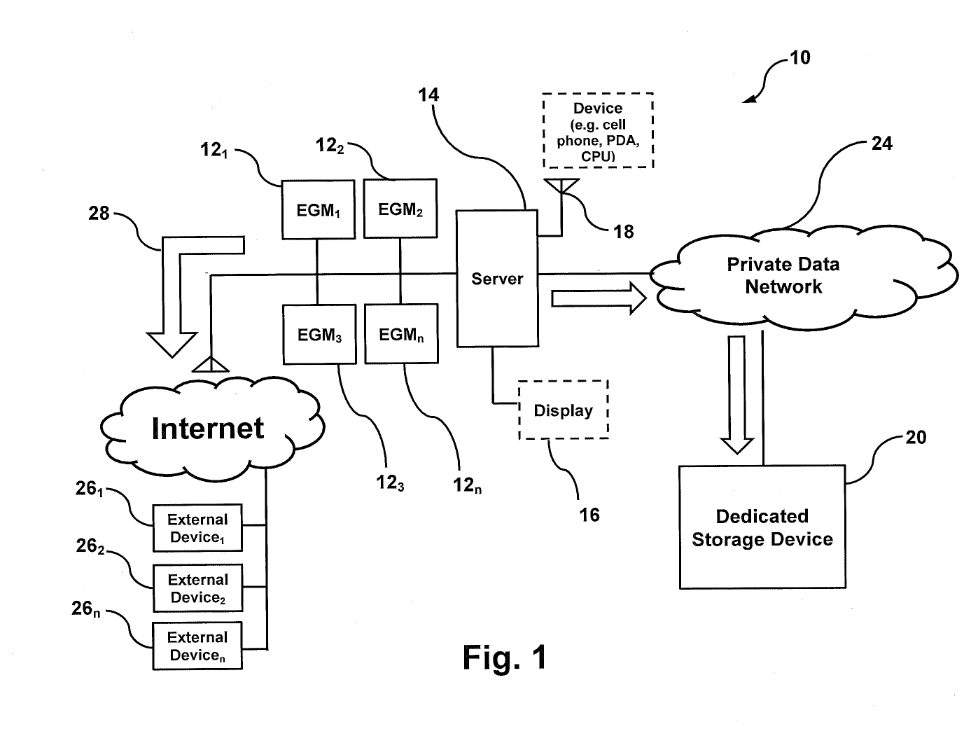

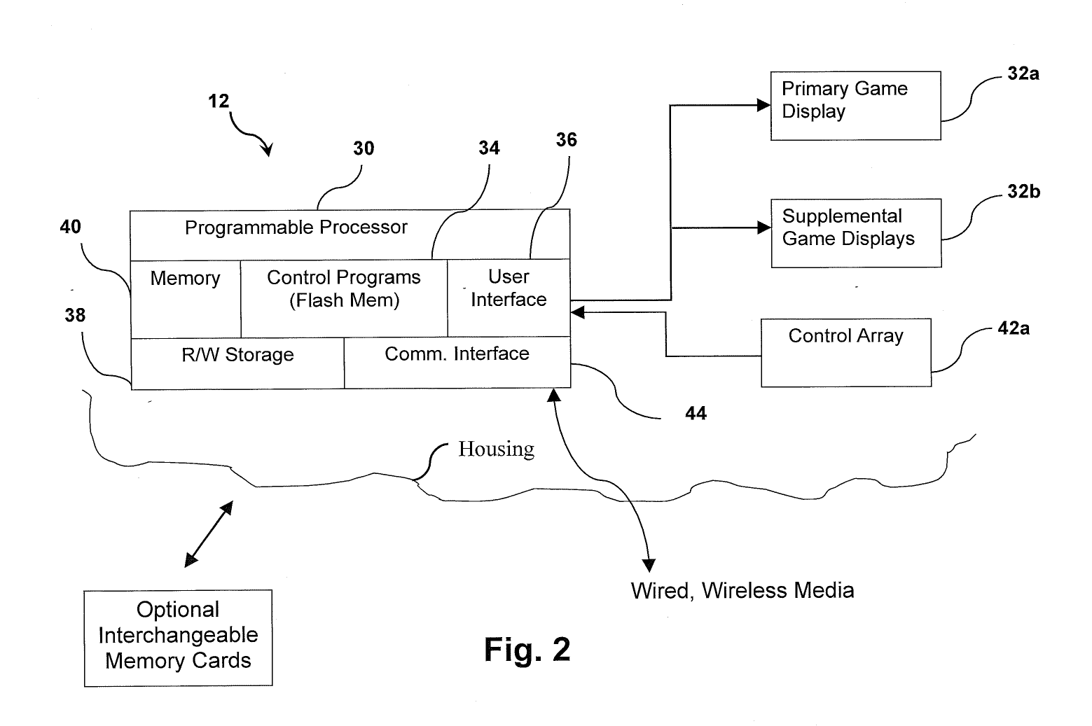

With reference now to the figures, FIG. 1 illustrates a representational view of a system 10 according to embodiments disclosed herein. As illustrated, the system 10 can feature one or more EGMs 12₁ . . . 12ₙ of the type described further herein and illustrated in more detail in FIG. 2. EGMs 12₁ . . . 12ₙ can be operably connected to a common server 14, which can be, for example, a dedicated device or a designated EGM in a bank comprising a plurality of EGMs which are networked or otherwise operably linked for communications purposes. It is preferred, but not required, that the common server 14 have electronic storage device for shared storage of electronic files and communications capabilities, such as for example a communication interface 18 and data transmission circuitry which can transmit electronic signals, data and files to other electronic devices such as servers, databases, cell phones, PDAs, computer tablets and/or other mobile electronic devices. The server 14 can additionally have a local display 16 operatively connected thereto which can be suitable for playing dynamic video content generated by EGMs 12₁ . . . 12ₙ.

The system 10 can additionally include a local or remote dedicated storage device 20, such as for example a one-way content server, database server or file server which can receive and store video files and other data transmitted from the server 14, but is preferably restricted from transmitting any data or other electronic communications in return. As shown in FIG. 1, the dedicated storage device 20 can have one or more data storage devices, database management systems for shared storage of video files and Digital Rights Management (DRM) technology which can control the use, viewing, copying of content, including digital video files.

According to embodiments presented herein, EGM 12₁ . . . 12ₙ can contain a central processor and associated circuitry for generating, capturing and/or recording live video of the machine's playing field or game array. Such recording can be made via frame buffering of display data, video recording of the display and/or mechanical elements of the device, or by any other method known or reasonably understood by persons of ordinary skill in the art. EGM 12₁ . . . 12ₙ can create an electronic video file for the video and the video output content can be any form of standard video such as, for example, QuickTime or WMV which can be replayed with any computer or other device having the appropriate playback software. The video content can be locally recorded to a local storage device of the EGM 12₁ . . . 12ₙ such as a hard drive, flash drive, and/or can be actively provided or “pushed” to a remote electronic device such as, for example, the server 14, having its own electronic storage device.

From the common server 14, the video content can be transmitted or pushed via Wi-Fi or other wired or wireless communications means to the dedicated storage device 20 which can receive data from the server 14, but is preferably restricted from transmitting any data or other communication in return. For security and/or regulatory purposes, the EGMs 12₁ . . . 12ₙ, server 14 and dedicated device 20 can be operably connected via a wired or wireless private data connection or network 24 so that only authorized persons can access the original video content from an EGM 12₁ . . . 12ₙ.

It has been determined that such processing and transmission of video content from an EGM 12₁ . . . 12ₙ can be useful for a variety of purposes. For example, the manufacturer or developer of the EGM, or service technicians, could review the video for playability and correct operation. Alternatively, the personnel from the gaming establishment could review the video to verify an outcome or for security purposes. It will additionally be recognized that regulatory personnel can also be permitted access to the video in order to use it for spot-checking play of the EGM. Moreover, marketers could use it to review play patterns in the EGM facility in order to improve players' gaming experiences. Other uses for such recorded video will be further apparent to those of ordinary skill in the relevant art.

It is further preferred that the system 10 contain a one way data connection and associated circuitry 28 for transmitting data to external electronic devices 26₁ . . . 26ₙ. The one-way connection 28 can be networked (e.g. via the global computer network or internet) to devices and/or public networks, other than the EGM 12₁ . . . 12ₙ and/or server 14 maintained by a central gaming venue. Such one-way communication can enable recorded video content from an EGM 12₁ . . . 12ₙ to be accessible by other devices outside the regulated/secure private gaming venue. Incidental and ancillary communications from the external device (e.g. “Communication active, clear to send recorded video”) can also be allowed, but for regulatory and/or security purposes, it is preferred that no communication be allowed from an external device 26₁ . . . 26ₙ to the server 14.

Once the recorded video from the EGM 12₁ . . . 12ₙ is transmitted to an external device 26₁ . . . 26ₙ, it will be recognized that the content can be accessed, played or shared like any other video file and used for an almost infinite variety of purposes. For example, the file could be publicly accessible or accessible to a predetermined subset of players having player loyalty accounts, and can further be shared or accessed through social media, or dedicated computer/tablet/device applications. The video content could further be used, for example, to directly or indirectly advertise the EGM, the game and/or the facility which maintains and operates the EGM, by showing actual winning outcomes.

The display 16 operatively connected to the common server 14 can be any type of conventional electronic video display unit, including for example, a CRT, high resolution flat-panel LCD, plasma, LED display which can visually present video content transmitted to the server 14. Display of the video content can be presented in order to play winning outcomes or historical plays on the plurality of EGMs 12₁ . . . 12ₙ connected to the server 14. Such display can be performed either alternatively or in addition to being pushed to the dedicated storage device 20. It will be recognized that the local presentation of the video from an EGM 12₁ . . . 12ₙ can be used for a number of purposes. For instance, the video content can be accessible to personnel of the gaming venue in order to monitor play of the EGM. In addition, it will be recognized that winning outcomes can be shown to potential players at the gaming venue for purposes of enhancing excitement and promoting play.

The communication interface 18 coupled to the common server 14 can enable technicians, customer servers persons and/or regulatory and enforcement personnel to access the server 14 through dedicated or general-purpose devices with proper applications to allow access to and playback of the recorded video. Such devices can include, for example, cellular phones, PDAs, computers, tablets, smart phones or any other electronic devices capable for uploading and processing video content. It will be recognized that accessing video content via the server 14 can enable persons to review recorded video to settle customer disputes about wins, review for regulatory compliance, and otherwise improve access to the play history of an EGM 12₁ . . . 12ₙ without disrupting current play and/or requiring the use of the machine upon which the play originally occurred.

FIG. 2 illustrates a representational view of the components of an EGM 12 according to embodiments of the subject invention. The gaming machine 12 can include a programmable processor 30 (such as for example a microprocessor or microcontroller) coupled to one or more game displays 32a, 32b. The processor 30 can include control programs 34 and associated circuitry, a user interface 36 with input/output circuits and at least one storage unit 38 which can store a plurality of instructions executable by the processor 30. The processor 30 can also include a memory unit 40 which can include a main memory containing dynamic information processed by the processor 30 during operation, and/or a static memory which contains fixed information, such as, for example, an operating system, game programs, and a configuration of information necessary for the processor 30 to consistently process input from a player through a control array 42. The control array can be one or more of a keyboard, mechanical lever, a touch-screen, buttons or pads and/or any other means for control, or desired combination of controls, able to accept input from a player and produce output to the game display 32a, 32b in response to a player's input.

According to embodiments set forth herein, the EGM 12 can output a video signal to display 32a, 32b for presenting as a dynamic video image and can further store the video signal in real-time in the storage unit 30 when a game is being played so as to allow the video signal to be transmitted and/or re-played. The gaming device 12 can begin storing the video signal when a play (or “pull”) begins and can store the video signal exactly as displayed on the screen until the play (or “pull”) ends. Embodiments disclosed herein can further provide for an EGM 12₁ . . . 12ₙ, server 14 and/or storage device 20 to store each individual game or pull as a separate and identifiable video output file. In addition, the video file can be played back with or without overlays which can visually identify video output as being from a pre-recorded game.

The gaming machine 12 can additionally feature communication means for transmitting a video file and related game information to a remote computer, network or display device, such as for example the server 14, dedicated storage device 20 or external device 26₁ . . . 26ₙ where the video file can be stored and/or replayed at will and without the use of the original electronic gaming device 12. Such communication means can include a communication interface 44 for communicating with other computers, networks or displays via wired or wireless media 46.

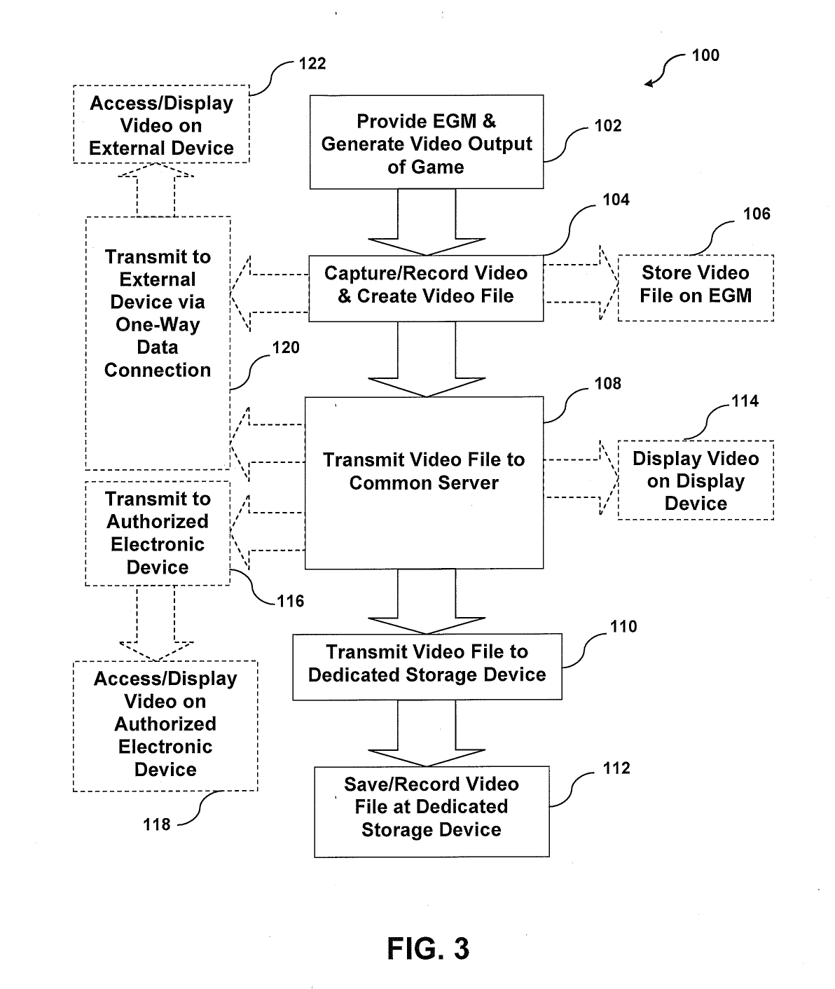

FIG. 3 illustrates a block diagram a method 100 for processing and transmitting video content from an EGM according to embodiments presented herein. According to such method 100, during play of a game an EGM can generate 102 video output of the game and capture/record 104 the video as a video file. The video file can be stored 106 locally at the EGM and/or transmitted 108 to an external electronic device such as the server 14. The video file can be securely transmitted 110 from the common server 14 to a dedicated electronic storage device 20 where it can be saved or recorded 112 in a database or other electronic storage device. The video file can also, or alternatively, be accessed by the server and visually presented 114 on display 16, and/or transmitted 116 by the server 14 via secured wired or wireless connection to an authorized electronic device, such as a computer tablet, laptop or smart phone or PDA which can remotely access and play 118 the video.

The video can further be transmitted 120 from an EGM 12₁ . . . 12ₙ or common server 14 to an external electronic device 26₁ . . . 26ₙ via a one-way public or private data connection or network 28, where the video can be remotely accessed and played 122 on a display unit associated with the external device 26₁ . . . 26ₙ.

As will be understood by those of ordinary skill in the art, while the description above details the preferred and best mode(s) of practicing the invention, many other configurations and variations are possible. For example, the invention need not be practiced with a commercial/regulated gaming system, but could be used with a variety of coin-operated amusement devices, home gaming systems, or any other appropriate system. Accordingly, the scope of the invention should be determined not by the embodiment(s) illustrated, but by the claims below and their equivalents.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

Further, logic flows depicted in the figures do not require the particular order shown, or sequential order, to achieve desirable results. Other steps may be provided, or steps may be eliminated, from the described flows, and other components may be added to, or removed from the described embodiments.

What is claimed is:

1. A system for processing video content of an electronic gaming machine comprising:
at least one electronic gaming machine having a central processor and associated circuitry for generating dynamic video of a game played thereon and creating an electronic file of the video;
a common computing server operatively connected to the at least one electronic gaming machine, the server having a storage device and first data transmission circuitry for transmission of the video file via a private data network;
a dedicated storage device in wired or wireless communication with the common server, the dedicated storage device having electronic data storage and one-way data acquisition circuitry for receiving the video file from the common server via the network; and
second data transmission circuitry electrically connected to the at least one electronic gaming machine or common server, the second data transmission circuitry suitable for one-way electronic transmission of the video file to an external device via a public or private data network.

2. The system of claim 1 further comprising an electronic display device operatively connected to the common server, the display device visually presenting at least a portion of the video.

3. The system of claim 2 where the display device comprises a CRT, LCD, plasma or LED display.

4. The system of claim 1 where the common server has a communication interface for transmitting the video file via a private network to an electronic device comprising at least one of a laptop computer, PDA, smartphone, computer tablet or other mobile electronic device.

5. The system of claim 1 comprising a plurality of electronic gaming machines operatively connected to the common server.

6. The system of claim 5 where the common server is physically located proximate a bank of the plurality of electronic gaming machines.

7. The system of claim 1 where the electronic gaming machine has at least one electronic display and a user interface coupled to the processor.

8. The system of claim 1 where the electronic gaming machine has an electronic storage device for locally storing the video.

9. The system of claim 1 where the dedicated storage device is at least one of a one-way content server, database server or file server.

10. A method for processing video content of an electronic gaming machine comprising:
providing an electronic gaming machine for generating dynamic video of a game played thereon;
creating an electronic video file of the video;
transmitting the video file to a server electronically connected to the gaming machine;
transmitting the video file to a dedicated storage device having an electronic storage device; and
saving the video file to the electronic storage device.

11. The method of claim 10 further comprising accessing the video file on the server and displaying at least a portion of the video on an electronic display device coupled to the server.

12. The method of claim 10 where transmitting the video file to the dedicated storage device is accomplished via a private data network.

13. The method of claim 10 further comprising transmitting the video file from the server to an electronic device comprising a smart phone, PDA, laptop computer, computer tablet or other mobile electronic device.

14. The method of claim 13 further comprising accessing the video file on the electronic device and presenting at least a portion of the video on an electronic display thereof.

15. The method of claim 10 further comprising transmitting the video file from the gaming machine or server to an external electronic device via a one-way public or private data network connection.

16. The method of claim 15 further comprising accessing the video file on the external electronic device and presenting at least a portion of the video on an electronic display thereof.

17. A device for processing video content of an electronic gaming machine comprising:
a plurality of electronic gaming machines having a central processor and associated circuitry for generating dynamic video of a game played thereon and creating an electronic file of the video, the plurality of machines having local data storage and a communication interface for wired or wireless connection to a common server;
a common computing server operatively connected to the plurality of electronic gaming machines, the server having a storage device and first data transmission circuitry for transmission of the video file via a public or private data network;
a display unit operatively connected to the common server or plurality of electronic gaming machines;
a dedicated storage device in wired or wireless communication with the common server, the dedicated storage device having electronic data storage and one-way data acquisition circuitry for receiving the video file from the common server via the network; and
second data transmission circuitry electrically connected to the plurality of electronic gaming machines or common server, the second data transmission circuitry suitable for one-way electronic transmission of the video file to an external device via a public or private data network.
